(19) United States
(12) Patent Application Publication
(10) Pub. No.: US 2009/0007677 A1
(43) Pub. Date: Jan. 8, 2009

(54) Ultrasonic distance measurement with high peak and low peak detection

(76) Inventor: Shih Chin Yang, Taipei (TW)

Correspondence Address: Shih-Chin Yang, 1199 Wunderlich Drive, San Jose, CA, 95129, US

(21) Appl. No.: 12/217,383

(22) Filed: Jul. 7, 2008

Related U.S. Application Data
(60) Provisional application No. 60/958,238, filed on Jul. 5, 2007.

(51) Int. Cl. G01H 5/00

(52) U.S. Cl. 73/597

(57) ABSTRACT

Present invention provides an improved ultrasonic receiving unit for ultrasonic distance measurement. The ultrasonic receiving features a high peak detection unit 120, a low peak detection unit 125, an arrival time adjustment unit 130. With those features, detection error caused by single threshold could be eliminated.

### CROSS-REFERENCE TO RELATED APPLICATION

This non-provisional patent application claims the benefits of prior provisional patent application, No. 60/958,238, ultrasonic distance measurement with high peak and low peak detection.

### BACKGROUND-FIELD OF INVENTION

The present invention relates generally to the area of distance measurement, specifically in the field of ultrasonic distance measurement.

### BACKGROUND-DESCRIPTION OF PRIOR ART

It is common to measure distance based on elapsed time measured between sending ultrasonic wave and receiving ultrasonic wave. With the time measured and known sound speed, the distance could be calculated.

U.S. Pat. Nos. 6,323,441, 4,910,717, 5,587,969, 5,032,793, 4,984,449 illustrates several different designs to measure distance based on detection of arrival time of ultrasonic energy.

To determine the ultrasonic wave arrival time, the simplest way is to compare the received ultrasonic signal with a threshold, when the received ultrasonic signal exceeds a threshold, a pulse is generated to signify the arrival of ultrasonic signal. However, this method has its own drawback, because ultrasonic signal attenuates when distance increases between transmitter and receiver. As shown if FIG. 2, received ultrasonic signal is a rising sine wave, when a high peak 210 of ultrasonic signal exceeds the high threshold, it signifies the arrival time of ultrasonic energy. But since the same peak 201 attenuates as distance become large, which would become so weak that it does not exceed the high threshold. So the peak 210 is never detected, instead, next high peak 214 with higher intensity is detected. Detecting wrong peak causes the measured distance by a factor of a wavelength of ultrasonic signal. For 40 KHz ultrasonic signal, the error would be approximated 8 mm.

Therefore, there is a need to improve the distance measurement accuracy while keeping a simple detecting structure.

### SUMMARY

Present invention uses 2 thresholds to increase the accuracy of above method. Since ultrasonic signal is a rising sine wave, there are high peaks that represent positive voltage, and there are low peaks that represent negative voltage. Present invention has a high peak detection using a reference high threshold on positive voltage, and another low peak detection using low threshold on negative voltage. When a peak of received ultrasonic signal becomes so weak that it does not exceed one of the thresholds, the next peak on the opposite voltage is detected. Even though wrong peak is detected, the error is half a wavelength of ultrasonic signal. For 40 KHz ultrasonic signal, the error would be approximated 4 mm, which improves the error by a factor of 2. Further, present invention adjusts the arrival time to correct the error to be 0.

### DRAWING FIGURES

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 shows the perspective view of an ultrasonic receiving unit;

FIG. 2 shows the prior art detection of received ultrasonic waveform;

FIG. 3 shows present invention detection of received ultrasonic waveform.

### REFERENCE NUMERALS IN DRAWINGS

100 Block diagram of ultrasonic distance measurement with high peak and low peak detection
110 Ultrasonic receiver
115 Amplifier
120 High peak detection unit
125 Low peak detection unit
130 Arrival time adjustment unit
140 Distance calculation unit
200 Prior art detection of received ultrasonic waveform
210 First high peak of received waveform
212 First low peak of received waveform
214 Second high peak of received waveform
220 High threshold
310 Low threshold
320 Half of a period time

### DETAILED DESCRIPTION

This chapter explains present invention in such greater detail so any person skilled in the art would be readily able to make a product based on the outlined principle. One preferred embodiment of present invention is shown. It is obvious that various embodiments could be derived from principle of present invention.

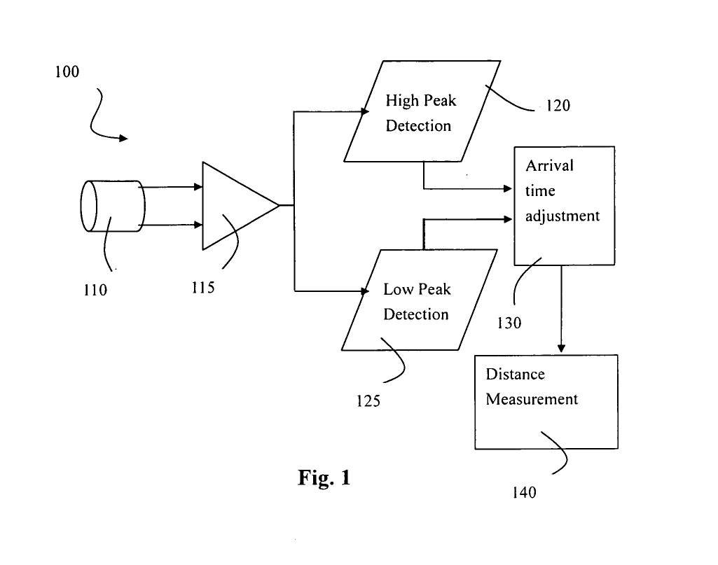

Referring to FIG. 1, present invention has an ultrasonic receiver 110, the received signal is amplified by an amplifier 115. Then high peak detection unit 120 compares amplified signal with a high threshold 220, when positive waveform exceeds high threshold, a pulse is triggered into an arrival time adjustment unit 130. Likewise, a low peak detection unit 125 compares amplified signal with a low threshold 310, when negative waveform exceeds low threshold, a pulse is triggered into an arrival time adjustment unit 130. The arrival time adjustment unit 130 could adjust arrival time by half of a period time to compensate the arrival time difference between a high peak 210 and a low peak 212. After arrival time adjustment, distance calculation unit 140 would compute the distance traveled by multiplying the measured time with known sound speed.

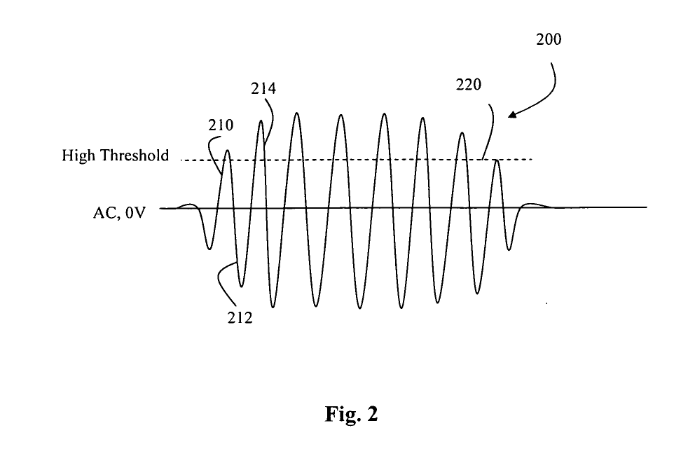

Referring to FIG. 2, when a low threshold 310 is not present in detection of prior art, when first high peak 210 attenuates below high threshold 220, the second high peak 214 would be detected by high threshold 220. This causes a time error of equivalent to one period time. For a 40 KHz signal, it translates to about 8 mm of measured error.

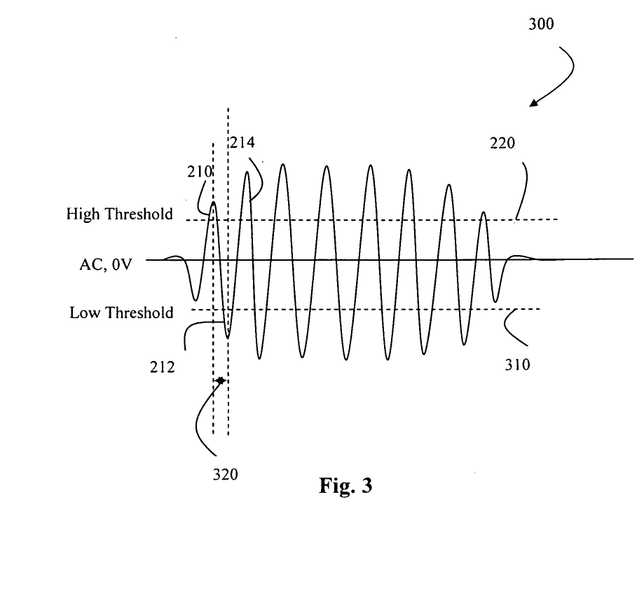

Referring to FIG. 3, when a low threshold 310 is employed in low peak detection 125 of present invention, when first high peak 210 attenuates below high threshold 220, the first low peak 212 would be detected by low threshold 310. The time error between first low peak 212 and first high peak 210 is half of a period time. Arrival time adjustment unit 130 would be able to differentiate between high peak detection 120 trigger and low peak detection 125 trigger, therefore, adjust by half of a period time according. And the distance measured would be the same as measured by first high peak 210.

Therefore, present invention provides a more accurate, economic, improvement over prior arts.

What is claimed is:

1. An ultrasonic receive unit for ultrasonic distance measurement, comprising of an ultrasonic receiver;
an amplifier;
an high peak detection unit;
an low peak detection unit;
an distance calculation unit.

2. An ultrasonic receive unit for ultrasonic distance measurement of claim 1, wherein further includes an arrival time adjustment unit, said arrival time adjustment unit distinguishes between said high peak detection input and said low peak detection input.

3. An ultrasonic receive unit for ultrasonic distance measurement of claim 2, wherein said arrival time adjustment unit compensates half of a time period of receive ultrasonic signal between said low peak detection input and said high peak detection input.

4. An ultrasonic receive unit for ultrasonic distance measurement, comprising of an ultrasonic receiver;
an amplifier;
an high peak detection unit;
an low peak detection unit;
an arrival time adjustment unit;
an distance calculation unit;
said arrival time adjustment unit distinguishes between said high peak detection input and said low peak detection input;
said arrival time adjustment unit compensates half of a time period of receive ultrasonic signal between said low peak detection input and said high peak detection input.
